(19) United States
(12) Patent Application Publication
(10) Pub. No.: US 2008/0269415 A1
(43) Pub. Date: Oct. 30, 2008

(54) Polyurethane Compounds Containing Hydroxyl Terminated Uretdione Groups

(75) Inventors: Emmanouil Spyrou, Schermbeck (DE); Rainer Lomolder, Munster (DE); Dirk Hoppe, Nottuln (DE); Christoph Nacke, Schermbeck (DE); Andre Raukamp, Rosendahl-Holtwick (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Degussa GmbH, Dusseldorf (DE)

(21) Appl. No.: 11/576,703

(22) PCT Filed: Sep. 8, 2005
(86) PCT No.: PCT/EP05/54444

§ 371 Date: Aug. 23, 2007

(30) Foreign Application Priority Data
Oct. 7, 2004 (DE) 10 2004 048 773.1

(51) Int. Cl. C08G 18/72; C08L 75/04

(52) U.S. Cl. 525/123; 528/67; 525/418

(57) ABSTRACT

The invention relates to specific, hydroxyl-terminated polyurethane compounds containing uretdione groups and intended for use in the plastics sector.

The invention relates to specific, hydroxyl-terminated polyurethane compounds containing uretdione groups and intended for use in the plastics sector.

Polyurethane compositions containing uretdione groups are known.

DE 10 14 70 describes reaction products of aromatic diisocyanates, containing uretdione groups, and difunctional hydroxyl compounds. The use of diisocyanates is not mentioned.

DE 95 29 40, DE 96 85 66 and DE 11 53 900 describe reaction products of diisocyanates, diisocyanates containing uretdione groups, and difunctional hydroxyl compounds. Mention is only made of aromatic isocyanate derivatives, however, which are known to lack weathering stability and tend toward yellowing.

DE 20 44 838 claims the continuation reaction of polyurethane compositions, containing uretdione groups, with polyamines. Here again only aromatic diisocyanates are mentioned.

DE 22 21 170 describes the reaction of NCO-terminated polyurethane compositions, containing uretdione groups, with diamines, with retention of the uretdione groups. The resultant urea structures are frequently undesirable on account of their incompatibility and brittleness.

DE 24 20 475 includes the description of a process for preparing powder coating crosslinkers which are composed of diisocyanates containing uretdione groups, of diisocyanates, and of difunctional hydroxyl compounds, the latter being restricted to the molecular range from 62 to 300 g/mol.

U.S. Pat. No. 4,496,684 mentions reaction products of diisocyanates containing uretdione groups and of difunctional hydroxyl compounds, which are intended for subsequent crosslinking with acid anhydrides. The use of diisocyanates is not described.

A process for preparing polyurethane compositions containing uretdione groups is described in EP 0 269 943, wherein at least 50% of the diisocyanates used contain uretdione groups.

EP 0 601 793 describes one-component adhesives composed of polyisocyanates containing uretdione groups, of polyisocyanates, and of polyols, the ratio of uretdione groups to free alcohols in the end product being not more than 1:1.

EP 0 640 634 describes polyurethane compositions which contain uretdione groups and additionally contain isocyanurate groups as well. Such isocyanurate groups result in lower flexibility.

EP 1 063 251 describes a process for preparing polyurethane compounds containing uretdione groups. It involves mixing diisocyanates with polyisocyanates containing uretdione groups, the diisocyanate component accounting for not more than 70% by weight of the sum of the two components.

It was an object of this invention to find specific polyurethane compounds, containing uretdione groups, which at one and the same time are free from yellowing, exhibit a high molar mass, and are more reactive than comparable known polyurethane compositions.

Surprisingly it has been found that the polyurethane compounds of the invention, based on aliphatic, (cyclo-)aliphatic and cycloaliphatic polyisocyanates, polyisocyanates containing uretdione groups, and polyols, are simultaneously yellowing-free, of high molecular mass, and more reactive than conventional products if the ratio of uretdione to alcohol groups in such a polyurethane compound is greater than 1:1.

The invention provides hydroxyl-terminated polyurethane compounds containing uretdione groups and comprising the reaction product of
A) aliphatic, (cyclo-)aliphatic and/or cycloaliphatic polyisocyanates having at least two NCO groups and
B) aliphatic, (cyclo-)aliphatic and/or cycloaliphatic polyisocyanates containing uretdione groups,
   A) in the mixture of A) and B) having a fraction of more than 70% by weight, with
C) oligomeric and/or polymeric polyols having an average molar mass of at least 301 g/mol and an OH number of 20 to 500 mg KOH/gram;
   the ratio of free NCO groups to alcohol groups in the starting materials being less than 1:1, and at the same time the ratio of uretdione groups to free alcohol groups in the end product being greater than 1:1;
   and it being possible for further auxiliaries and additives to be included.

Suitable polyisocyanates A) are aliphatic, (cyclo-)aliphatic and/or cycloaliphatic polyisocyanates having at least two NCO groups, and more particularly the following: isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/-2,4,4-trimethylhexamethylene diisocyanate (TMDI), norbornane diisocyanate (NBDI), and/or methylenediphenyl diisocyanate (MDI), and also tetramethylxylylene diisocyanate (TMXDI) used with preference. Very particular preference is given to IPDI, HDI, and H₁₂MDI.

Polyisocyanates containing uretdione groups, B), are well known and are described for example in U.S. Pat. No. 4,476,054, U.S. Pat. No. 4,912,210, U.S. Pat. No. 4,929,724, and EP 0 417 603. A comprehensive overview of industrially relevant processes for dimerizing isocyanates to uretdiones is offered by J. Prakt. Chem. 336 (1994) 185-200. Conversion of isocyanates to uretdiones generally takes place in the presence of soluble dimerization catalysts, such as dialkylaminopyridines, trialkylphosphines, phosphoramides, triazole derivatives or imidazoles, for example. The reaction—conducted optionally in solvents but preferably in their absence—is terminated by addition of catalyst poisons when a desired conversion has been reached. Excess monomeric isocyanate is separated off afterward by short-path evaporation. If the catalyst is sufficiently volatile the reaction mixture can be freed from the catalyst at the same time as the monomer is separated off. In that case there is no need to add catalyst poisons. A broad range of aliphatic, (cyclo)aliphatic and/or cycloaliphatic isocyanates is suitable in principle for preparing polyisocyanates containing uretdione groups. Preferred for use in accordance with the invention are isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), and/or methylenediphenyl diisocyanate (MDI), and also tetramethylxylylene diioscyanate (TMXDI). The dimerization of H₁₂MDI was described only recently in WO 04005363 and WO 04005364.

Very particular preference is given to IPDI, HDI and H₁₂MDI.

With regard to the hydroxyl-containing oligomeric or polymeric polyols C) having an OH number of 20 to 500 (in mg KOH/gram) and a molar mass of at least 301 g/mol it is preferred to use polyesters, polyethers, polyacrylates, polyurethanes, polyethers and/or polycarbonates. Very particular preference is given to using hydroxyl-containing polyesters having an OH number of 20 to 150 mg KOH/gram and an average molecular weight of 500 to 6000 g/mol. It will be appreciated that mixtures of such polyols can also be used.

Auxiliaries and additives such as flow-control agents, e.g., polysilicones or acrylates, light stabilizers, e.g., sterically hindered amines, or other auxiliaries, as described for example in EP 0 669 353, can be added in a total amount of 0.05% to 5% by weight; fillers and pigments, such as titanium dioxides, for example, can be added in an amount up to 50% by weight of the overall composition. Catalysts such as are already known in polyurethane chemistry may optionally be included. These are primarily organometallic catalysts, such as dibutyltin dilaurate, for example, or else tertiary amines, such as 1,4-diazabicyclo[2.2.2]octane, for example, in amounts of 0.001% to 1% by weight.

The conversion of the polyisocyanates A) and the polyisocyanates B) carrying uretdione groups to the polyurethane compounds of the invention involves the reaction of the free NCO groups of A) and B) with hydroxyl-containing oligomers or polymers of C).

In accordance with the invention it is necessary for the ratio of free NCO groups to alcohol groups here to be less than 1:1. In the end product, however, the ratio of the uretdione groups to the now numerically reduced (by reaction with free NCO groups) alcohol groups ought at the same time to be greater than 1:1.

The invention also provides a process for preparing the polyurethane compounds of the invention in solution.

The inventive preparation of the polyurethane compounds of the invention in solution can take place by reacting A) and B) with C) in suitable equipment, such as stirred tanks or static mixers, for example. The reaction temperature in this context is from 40 to 220° C., preferably 40 to 120° C. Suitable solvents involve, as is known, all liquid substances which are not reactive toward isocyanate groups, such as, for example, acetone, ethyl acetate, butyl acetate, Solvesso, N-methylpyrrolidine, dimethylformamide, methylene chloride, tetrahydrofuran, dioxane, methoxypropyl acetate, and toluene. After the end of reaction the solvent is removed by appropriate methods, such as distillation, including short-path distillation, or spray drying, for example, giving the desired product in pure form.

The invention also provides a process for solvent-free preparation of the polyurethane compounds of the invention.

In this case the reaction of A) and B) with C) takes place in mechanical mixing equipment, in particular in an extruder, intensive compounder, intensive mixer or static mixer, by intensive commixing and short-duration reaction with supply of heat, and the end product is subsequently isolated by rapid cooling.

The principle of the process is that the reaction of the starting compounds takes place continuously, in particular in an extruder, intensive compounder, intensive mixer or static mixer, by intensive commixing and short-duration reaction with supply of heat. Short duration means that the residence time of the reactants in the abovementioned equipment is usually 3 seconds to 15 minutes, preferably 3 seconds to 5 minutes, more preferably 5 to 180 seconds. The reactants are reacted with short duration and with supply of heat at temperatures of 25° C. to 325° C., preferably of 50 to 250° C., very preferably of 70 to 220° C. Depending on the nature of the reactants and end products, however, it is also possible for these residence time and temperature values to occupy other, preferred ranges. If desired a continuous afterreaction is included afterward. Subsequent rapid cooling then gives the end product.

Equipment particularly suitable and used with preference for the process of the invention embraces extruders such as single-screw or multi-screw extruders, especially twin-screw extruders, planetary-roll extruders or annular extruders, intensive compounders, intensive mixers or static mixers.

The starting compounds are metered to the equipment generally in separate product streams. Where there are more than two product streams, these streams can also be supplied in bundled form. Different hydroxyl-containing polymers can be combined into one product stream. It is also possible additionally to add catalysts and/or adjuvants such as flow control agents, stabilizers, acid scavengers or adhesion promoters to this product stream. Similarly, polyisocyanates, and also the uretdione or uretdiones of polyisocyanates, together with catalysts and/or adjuvants such as flow control agents, stabilizers, acid scavengers or adhesion promoters, can be combined into one product stream. The streams may also be divided and so supplied in different proportions to different sites in the equipment. In this way, in a targeted fashion, concentration gradients are set up, and this may induce the reaction to proceed to completion. The entry point of the product streams can be varied in sequence and offset in time.

For a preliminary reaction and/or for completion of the reaction it is also possible for two or more pieces of equipment to be combined.

The cooling downstream of the rapid reaction can be integrated in the reaction section, in the form of a multibarrel embodiment such as in the case of extruders or Conterna machines. The following may also be employed: tube bundles, tubular coils, chill rolls, air conveyors, metal conveyor belts, and water baths, with and without a downstream pelletizer.

The formulation is first of all brought to an appropriate temperature by means of further cooling using corresponding abovementioned apparatus, depending on the viscosity of the product leaving the intensive compounder zone or the afterreaction zone. This is followed by pelletizing or else by comminution to a desired particle size by means of a roll crusher, pin mill, hammer mill, flaking rolls, strand pelletizer (in combination with a water bath, for example), other pelletizers or the like.

The invention further provides for the use of the uretdione-containing polyurethane compounds of the invention for producing thermoplastic polyurethanes (TPU) and molding compounds.

The invention also provides thermoplastic polyurethane molding compounds, said molding compounds comprising as hydroxyl-terminated polyurethane compounds containing uretdione groups the reaction product of
A) aliphatic, (cyclo-)aliphatic and/or cycloaliphatic polyisocyanates having at least two NCO groups and
B) aliphatic, (cyclo-)aliphatic and/or cycloaliphatic polyisocyanates containing uretdione groups,
   A) in the mixture of A) and B) having a fraction of more than 70% by weight, with
C) oligomeric or polymeric polyols having an average molar mass of at least 301 g/mol and an OH number of 20 to 500 mg KOH/gram;
   the ratio of free NCO groups to alcohol groups in the starting materials being less than 1:1,
   and at the same time the ratio of uretdione groups to free alcohol groups in the end product being greater than 1:1. Additionally the molding compounds may also comprise auxiliaries and additives and further polymers.

For this purpose the uretdione-containing polyurethane compounds of the invention may be mixed with polymers, optionally with polycarbonates, acrylonitrile copolymers, acrylonitrile-butadiene-styrene polymers, acrylonitrile-styrene-acrylic rubber molding compositions, copolymers of ethylene and/or propylene and also acrylic acid or methacrylic acid or sodium salts or Zn salts thereof, and also copolymers of ethylene and/or propylene and also acrylic esters or methacrylic esters, and auxiliaries and additives such as UV stabilizers and an antioxidants, for example.

The molding compounds of the invention can be prepared by mixing the TPU pellets, prepared by methods known in principle, with the respective adjuvants and compounding the mixture in a way which is known to the skilled worker, by reextrusion. Subsequently the resulting molding compound can be pelletized and converted by (cold) grinding to a sinterable powder suitable, for example, for processing by the powder slush process (see, for example, DE 39 32 923 or else U.S. Pat. No. 6,057,391). Such powders preferably have particle sizes of 50 to 500 μm. The molding compounds of the invention are suitable for producing a wide variety of moldings, examples including films and/or sintered sheets.

The films and/or sintered sheets produced from the polyurethane molding compounds of the invention are suitable for example for use as surface coverings in means of transport (e.g., aircraft, autos, ships, and railways).

The subject matter of the invention is illustrated below by reference to examples.

### EXAMPLE

| Ingredients | Product description, manufacturer |
|---|---|
| IPDI | Isophorone diisocyanate, NCO content |
| | 37.6%; Degussa AG |
| IPDI uretdione (UD) | From IPDI by dimerization, free NCO |
| | content 17.6%, latent NCO content: |
| | 19.6%; Degussa AG |
| DYNACOLL 7380 | (Partially) crystalline OH |
| | polyester, OH number 30 mg KOH/g, |
| | m.p.: 70° C., Degussa AG, Coatings & |
| | Colorants |
| DBTL | Dibutyltin dilaurate, Aldrich |

### Preparation of a Polyurethane Composition by the Process of the Invention

Three product streams were used:

Stream 1 was composed of DYNACOLL 7380 (OH number 30 mg KOH/g).

Stream 2 was composed of the mixture of 75.12% by weight of isophorone diisocyanate (IPDI) and 28.88% by weight of the uretdione of isophorone diisocyanate (IPDI).

Stream 3 was composed of the DBTL catalyst. The total amount based on the total formula was 0.10%.

Stream 1 was fed as a melt at a rate of 3110 g/h into the first barrel of the twin-screw extruder (DSE 25) (product stream temperature: 124° C.).

Stream 2 was fed into the next barrel at a rate of 199 g/h (product stream temperature: 70° C.).

Stream 3 was introduced through a nozzle into stream 2 prior to entry into the extruder.

The extruder used was composed of 8 barrels, which could be cooled and heated separately. Barrel 1: 20-90° C., Barrels 2-8: 90° C.

All temperatures were setpoint temperatures. Regulation took place via electrical heating and/or water cooling. The die was likewise heated electrically. The screw speed was 150 to 300 rpm. The throughput in this example was 3300 g/h.

The reaction product was cooled on a cooling belt and ground.

### Results:

| UD/IPDI ratio | 24.85:75.15 |
|---|---|
| OH:NCO molar ratio | 15:14 |
| Throughput (kg/h) | 3.3 |
| Revolutions/minute | 250 |
| Extrusion temperature (° C.) | 90 |
| Exit temperature (° C.) | 90 |
| DBTL (%) | 0.1 |
| Viscosity number (DIN 53728): | |
| Initial | 102 |
| After 30′ 180° C. | 130 |
| After 8 h 180° C. | 246 |
| Shore hardness (DIN 53505) | 56 D |
| Softening point (° C.) (DIN ISO 4625): | |
| Initial | 83 |
| 8 h 50° C. | 84 |
| 8 h 100° C. | 169 |

1. A hydroxyl-terminated polyurethane compound containing uretdione groups and comprising the reaction product of
A) aliphatic, (cyclo-)aliphatic and/or cycloaliphatic polyisocyanates having at least two NCO groups and
B) aliphatic, (cyclo-)aliphatic and/or cycloaliphatic polyisocyanates containing uretdione groups,
A) in the mixture of A) and B) having a fraction of more than 70% by weight, with
C) oligomeric and/or polymeric polyols having an average molar mass of at least 301 g/mol and an OH number of 20 to 500 mg KOH/gram;
the ratio of free NCO groups to alcohol groups in the starting materials being less than 1:1,
and at the same time the ratio of uretdione groups to free alcohol groups in the end product being greater than 1:1.

2. A hydroxyl-terminated polyurethane compound containing uretdione groups as claimed in claim 1, comprising further auxiliaries and additives.

3. A hydroxyl-terminated polyurethane compound containing uretdione groups, as claimed in claim 1, wherein as component A) polyisocyanates selected from isophorone diisocyanate (IPDI), hexamethylene diisocyanate (HDI), diisocyanatodicyclohexylmethane (H12MDI), 2 methylpentane diisocyanate (MPDI), 2,2,4 trimethylhexamethylene diisocyanate/2,4,4-trimethylhexamethylene diisocyanate (TMDI), norbornane diisocyanate (NBDI), methylenediphenyl diisocyanate (MDI and/or, tetramethylxylylene diisocyanate (TMXDI) are used.

4. A hydroxyl-terminated polyurethane compound containing uretdione groups, as claimed in claim 3, wherein IPDI, HDI and/or H12MDI are used.

5. A hydroxyl-terminated polyurethane compound containing uretdione groups, as claimed in claim 1, wherein as component B) polyisocyanates selected from isophorone diisocyanate (IPDI), hexamethylene diisocyanate (HDI), diisocyanatodicyclohexylmethane (H12MDI), 2 methylpentane diisocyanate (MPDI), 2,2,4 trimethylhexamethylene diisocyanate/2,4,4-trimethylhexamethylene diisocyanate (TMDI), norbornane diisocyanate (NBDI), methylenediphenyl diisocyanate (MDI), and/or tetramethylxylylene diisocyanate (TMXDI) are used.

6. A hydroxyl-terminated polyurethane compound containing uretdione groups, as claimed in claim 5, wherein IPDI, HDI, and H12MDI are used.

7. A hydroxyl-terminated polyurethane compound containing uretdione groups, as claimed in claim 1, wherein as component C polyesters, polyethers, polyacrylates, polyurethanes, polyethers and/or polycarbonates having an OH number of 20 to 500 (in mg KOH/gram) are used.

8. A hydroxyl-terminated polyurethane compound containing uretdione groups, as claimed in claim 1, wherein as component C) hydroxyl-containing polyesters having an OH number of 20 to 150 mg KOH/gram and an average molecular weight of 500 to 6000 g/mol are used.

9. A hydroxyl-terminated polyurethane compound containing uretdione groups, as claimed in claim 1, wherein auxiliaries and additives in a total amount of 0.05% to 5% by weight and/or fillers and pigments in amount up to 50% by weight of the total composition are used.

10. A hydroxyl-terminated polyurethane compound containing uretdione groups, as claimed in claim 1, wherein organometallic catalysts, and/or tertiary amines, are used in amounts of 0.001% to 1% by weight as auxiliaries additives.

11. A process for preparing a hydroxyl-terminated polyurethane compound containing uretdione groups as claimed in claim 1, which comprises preparing the polyurethane compound in solution by reacting A) and B) with C) at 40 to 220° C., preferably 40 to 120° C.

12. A process for preparing a hydroxyl-terminated polyurethane compound containing uretdione groups, as claimed in claim 1, wherein the polyurethane compound is prepared solventlessly by reacting A) and B) with C) in mechanical mixing equipment.

13. A process as claimed in claim 12, wherein the reaction takes place in an extruder, intensive compounder, intensive mixer or static mixer by intensive commixing and short-duration reaction with supply of heat, and the end product is isolated subsequently by rapid cooling.

14. A process as claimed in claim 12, wherein the reaction takes place in a single-screw, twin-screw or multi-screw extruder, annular extruder or planetary-roll extruder.

15. A process as claimed in claim 14, wherein the reaction takes place in a twin-screw extruder.

16. A process as claimed in claim 12, wherein the reaction takes place in an intensive mixer intensive compounder.

17. A process as claimed in claim 12, wherein the reaction takes place in a static mixer.

18. A process as claimed in claim 12, wherein the reaction takes place in an extruder, intensive compounder, intensive mixer or static mixer having two or more identical or different housings which can be thermally controlled independently of one another.

19. A process as claimed in claim 12, wherein the temperature in the extruder, intensive compounder, intensive mixer or static mixer is 10 to 250° C.

20. A process as claimed in claim 12, wherein the extruder or intensive compounder leads on the one hand, by means of appropriate outfitting of the mixing chambers and assembling of the screw geometry, to intensive, rapid commixing and rapid reaction with simultaneous intensive heat exchange, and on the other hand effects uniform continuous flow in longitudinal direction with a highly uniform residence time.

21. A process as claimed in claim 12, wherein the reaction takes place in the presence of catalysts and/or adjuvants.

22. A process as claimed in claim 12, wherein the ingredients and/or catalyst and/or adjuvants are supplied together or in separate product streams, in liquid or solid form, to the extruder, intensive compounder, intensive mixer or static mixer.

23. A process as claimed in claim 22, wherein the adjuvants are combined with the ingredients into or product stream.

24. A process as claimed in claim 12, wherein, in the event of there being more than two product streams, these streams are supplied in bundle form.

25. A process as claimed in claim 12, wherein one or both product streams are divided.

26. A process as claimed in claim 12, wherein the catalyst is combined with one of the product streams or is in solution in one of the streams.

27. A process as claimed in claim 12, wherein the adjuvant is combined with one of the product streams or is in solution in one of the streams.

28. A process as claimed in claim 12, wherein the entry point of the product streams is varied in order and offset in time.

29. The method for preparing a thermoplastic polyurethane (TPU) or molding compound using a uretdione-containing polyurethane compound.

30. A thermoplastic polyurethane molding compound comprising as hydroxyl-terminated polyurethane compound containing uretdione groups the reaction product of
A) aliphatic, (cyclo-)aliphatic and/or cycloaliphatic polyisocyanates having at least two NCO groups and
B) aliphatic, (cyclo-)aliphatic and/or cycloaliphatic polyisocyanates containing uretdione groups,
A) in the mixture of A) and B) having a fraction of more than 70% by weight, with
C) oligomeric or polymeric polyols having an average molar mass of at least 301 g/mol and an OH number of 20 to 500 mg KOH/gram;
the ratio of free NCO groups to alcohol groups in the starting materials being less than 1:1 and at the same time the ratio of uretdione groups to free alcohol groups in the end product being greater than 1:1.

31. A thermoplastic polyurethane molding compound as claimed in claim 30, comprising further auxiliaries and additives.

32. A thermoplastic polyurethane molding compound as claimed in claim 30, comprising further polymers selected from polycarbonates, acrylonitrile copolymers, acrylonitrile-butadiene-styrene polymers, acrylonitrile-styrene-acrylic rubber molding compounds, copolymers of ethylene and/or propylene and also acrylic acid or methacrylic acid or sodium salts or Zn salts thereof, and also copolymers of ethylene and/or propylene and also acrylic esters or methacrylic esters.
